(19) United States
(12) Patent Application Publication
(10) Pub. No.: US 2020/0083567 A1
(43) Pub. Date: Mar. 12, 2020

(54) MANUFACTURING METHOD OF ALL SOLID BATTERY

(71) Applicant: TAIYO YUDEN CO., LTD., Tokyo (JP)

(72) Inventors: Sachie TOMIZAWA, Takasaki-shi (JP); Daigo ITO, Takasaki-shi (JP); Chie KAWAMURA, Takasaki-shi (JP); Takato SATOH, Takasaki-shi (JP)

(21) Appl. No.: 16/560,285

(22) Filed: Sep. 4, 2019

(30) Foreign Application Priority Data
Sep. 11, 2018 (JP) 2018-169749

(51) Int. Cl. H01M 10/0585; H01M 4/04; H01M 4/66; H01M 10/0562

(52) U.S. Cl. CPC H01M 10/0585; H01M 4/0404; H01M 2300/0068; H01M 10/0562; H01M 4/661

(57) ABSTRACT

A manufacturing method of an all solid battery includes: preparing a multilayer structure in which first coated electric collector paste including Pd, first coated electrode paste including carbon, a green sheet including phosphoric acid salt-based solid electrolyte grains, second coated electrode paste including carbon and second coated electric collector paste including Pd are stacked in this order; and firing the multilayer structure within an oxygen partial pressure range from 5×10⁻²² atm or more and 2×10⁻¹³ atm or less.

### CROSS-REFERENCE TO RELATED APPLICATION

This application is based upon and claims the benefit of priority of the prior Japanese Patent Application No. 2018-169749, filed on Sep. 11, 2018, the entire contents of which are incorporated herein by reference.

### FIELD

A certain aspect of the present invention relates to a manufacturing method of an all solid battery.

### BACKGROUND

Recently, secondary batteries are being used in various fields. Secondary batteries having electrolytic liquid have a problem such as leak of the electrolytic liquid. And so, all solid batteries having a solid electrolyte and other solid elements are being developed. In all solid batteries that has a solid electrolyte layer of phosphoric acid salt and is formed by firing, it is preferable that a material hardly reacting with each material is used, as a metal used for an electric collector layer. For example, there is disclosed a technology in which Pd (palladium) is used as the electric collector layer (for example, see Japanese Patent Application Publication No. 2017-84643 hereinafter referred to as Document 1).

### SUMMARY OF THE INVENTION

The present invention has a purpose of providing a manufacturing method of an all solid battery that is capable of suppressing carbon loss and melting of phosphoric acid salt-based solid electrolyte.

According to an aspect of the present invention, there is provided a manufacturing method of an all solid battery including: preparing a multilayer structure in which first coated electric collector paste including Pd, first coated electrode paste including carbon, a green sheet including phosphoric acid salt-based solid electrolyte grains, second coated electrode paste including carbon and second coated electric collector paste including Pd are stacked in this order; and firing the multilayer structure within an oxygen partial pressure range from 5×10⁻²² atm or more and 2×10⁻¹³ atm or less.

### BRIEF DESCRIPTION OF THE DRAWINGS

FIG. 1 illustrates a schematic cross section of an all solid battery;

FIG. 2 illustrates a schematic cross section of another all solid battery;

FIG. 3 illustrates a flowchart of a manufacturing method of an all solid battery;

FIG. 4 illustrates a stacking process;

FIG. 5 illustrates aging of oxygen partial pressure;

FIG. 6 illustrates aging of oxygen partial pressure; and

FIG. 7 illustrates aging of oxygen partial pressure.

### DETAILED DESCRIPTION

It is thought that Pd is used as conductive auxiliary agent of electrode layers, with use of characteristic in which Pd hardly reacts each material. However, Pd in the electrode layers suppresses increasing of an amount of an added active material in the electrode layers. And so, it is preferable that carbon is used as the conductive auxiliary agent of the electrode layers. However, carbon may be lost in a process of firing a multilayer structure in which layers are stacked. And so, it is thought that strong reductive atmosphere is used as firing atmosphere. However, phosphoric acid salt-based solid electrolyte may be melted in the strong reductive atmosphere.

A description will be given of an embodiment with reference to the accompanying drawings.

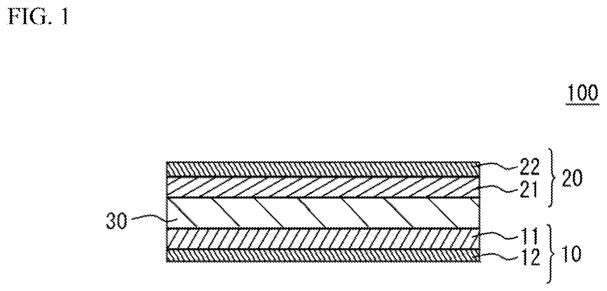

FIG. 1 illustrates a schematic cross section of an all solid battery 100 in accordance with an embodiment. As illustrated in FIG. 1, the all solid battery 100 has a structure in which a first electrode 10 and a second electrode 20 sandwich a phosphoric acid salt-based solid electrolyte layer 30. The first electrode 10 is provided on a first main face of the solid electrolyte layer 30. The first electrode 10 has a structure in which a first electrode layer 11 and a first electric collector layer 12 are stacked. The first electrode layer 11 is on the solid electrolyte layer 30 side. The second electrode 20 is provided on a second main face of the solid electrolyte layer 30. The second electrode 20 has a structure in which a second electrode layer 21 and a second electric collector layer 22 are stacked. The second electrode layer 21 is on the solid electrolyte layer 30 side.

When the all solid battery 100 is used as a secondary battery, one of the first electrode 10 and the second electrode 20 is used as a positive electrode and the other is used as a negative electrode. In the embodiment, as an example, the first electrode 10 is used as a positive electrode, and the second electrode 20 is used as a negative electrode.

At least, the solid electrolyte layer 30 is a phosphoric acid salt-based solid electrolyte. For example, the phosphoric acid salt-based electrolyte has a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the first electrode layer 11 and the second electrode layer 21 is added in advance, is used. For example, when the first electrode layer 11 and the second electrode layer 21 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte.

At least, the first electrode layer 11 used as a positive electrode includes a material having an olivine type crystal structure, as an electrode active material. It is preferable that the second electrode layer 21 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first electrode layer 11 acting as a positive electrode. For example, when only the first electrode layer 11 includes the electrode active material having the olivine type crystal structure, the electrode active material acts as the positive electrode active material. When the second electrode layer 21 also includes an electrode active material having the olivine type crystal structure, discharge capacity may increase and an operation voltage may increase because of electric discharge, in the second electrode layer 21 acting as a negative electrode. The function mechanism is not completely clear. However, the mechanism may be caused by partial solid-phase formation together with the negative electrode active material.

When both the first electrode layer 11 and the second electrode layer 21 include an electrode active material having the olivine type crystal structure, the electrode active material of each of the first electrode layer 11 and the second electrode layer 21 may have a common transition metal. Alternatively, the a transition metal of the electrode active material of the first electrode layer 11 may be different from that of the second electrode layer 21. The first electrode layer 11 and the second electrode layer 21 may have only single type of transition metal. The first electrode layer 11 and the second electrode layer 21 may have two or more types of transition metal. It is preferable that the first electrode layer 11 and the second electrode layer 21 have a common transition metal. It is more preferable that the electrode active materials of the both electrode layers have the same chemical composition. When the first electrode layer 11 and the second electrode layer 21 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second electrode layer 21 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second electrode layer 21. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first electrode layer 11 and the second electrode layer 21, moreover, oxide-based solid electrolyte material or a conductive material (conductive auxiliary agent) such as a carbon or a metal may be added. When the material is evenly dispersed into water or organic solution together with binder or plasticizer, paste for electrode layer is obtained. Pd, Ni, Cu, or Fe, or an alloy thereof may be used as a metal of the conductive auxiliary agent.

The first electric collector layer 12 and the second electric collector layer 22 are made of a conductive material.

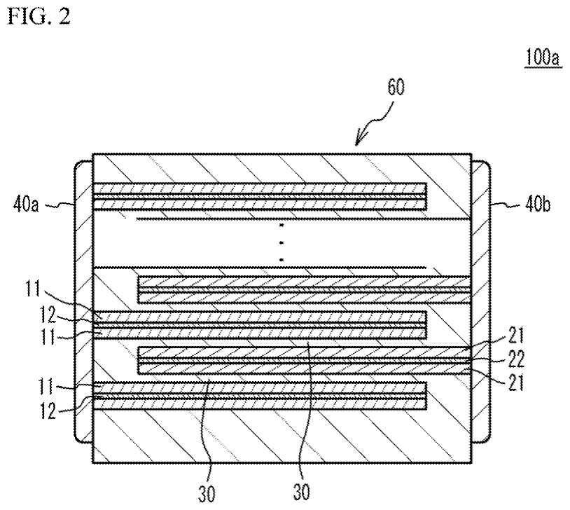

FIG. 2 illustrates a schematic cross section of an all solid battery 100a in accordance with another embodiment. The all solid battery 100a has a multilayer chip 60 having a rectangular parallelepiped shape, a first external electrode 40a provided on a first edge face of the multilayer chip 60, and a second external electrode 40b provided on a second edge face facing with the first edge face. In the following description, the same numeral is added to each member that is the same as that of the all solid battery 100. And, a detail explanation of the same member is omitted.

In the all solid battery 100a, each of the first electric collector layers 12 and each of the second electric collector layers 22 are alternately stacked. Edges of the first electric collector layers 12 are exposed to the first edge face of the multilayer chip 60 but are not exposed to the second edge face of the multilayer chip 60. Edges of the second electric collector layers 22 are exposed to the second edge face of the multilayer chip 60 but are not exposed to the first edge face. Thus, each of the first electric collector layers 12 and each of the second electric collector layers 22 are alternately conducted to the first external electrode 40a and the second external electrode 40b.

The first electrode layer 11 is stacked on the first electric collector layer 12. The solid electrolyte layer 30 is stacked on the first electrode layer 11. The solid electrolyte layer 30 extends from the first external electrode 40a to the second external electrode 40b. The second electrode layer 21 is stacked on the solid electrolyte layer 30. The second electric collector layer 22 is stacked on the second electrode layer 21. Another second electrode layer 21 is stacked on the second electric collector layer 22. Another solid electrolyte layer 30 is stacked on the second electrode layer 21. The solid electrolyte layer 30 extends from the first external electrode 40a to the second external electrode 40b. The first electrode layer 11 is stacked on the solid electrolyte layer 30. In the all solid battery 100a, the stack units are repeatedly stacked. Therefore, the all solid battery 100a has a structure in which a plurality of cell units are stacked.

It is preferable that a material which is hardly oxidized and hardly reacts with each material is used as a metal applied to the electric collector layer, in an all solid battery having phosphoric acid salt-based solid electrolyte and is manufactured by firing, as in the case of the all solid battery 100 or the all solid battery 100a. And so, the first electric collector layer 12 and the second electric collector layer 22 include Pd as a conductive material. Among metals, Pd has high adhesion with ceramics. Therefore, the first electrode layer 11 has high adhesion with the first electric collector layer 12. The second electrode layer 21 has high adhesion with the second electric collector layer 22. Therefore, when the first electric collector layer 12 and the second electric collector layer 22 include Pd, the all solid battery 100 achieve favorable performance.

It is thought that Pd is used as conductive auxiliary agent of the first electrode layer 11 and the second electrode layer 21, with use of characteristic in which Pd hardly reacts each material. However, it is preferable that a ratio of Pd in the first electrode layer 11 and the second electrode layer 21 is 20 vol. % to 50 vol. %, from a viewpoint of achieving conductive network in the electrode layers by spheroidizing of Pd and grain growing of Pd in the firing process. And, Pd prevents increasing of the amount of added active material in the electrode layers, when the volume fractional ratio of Pd is increased. Clarke number of Pd is extremely small. Therefore, Pd is very expensive. And so, it is preferable that carbon is used as conductive auxiliary agent of the first electrode layer 11 and the second electrode layer 21. On the other hand, carbon is not spheroidized. And, grains of carbon does not grow. Therefore, carbon hardly prevents increasing of the amount of the added active material in the electrode layers, because carbons achieves high conductivity with a less volume fractional ratio. Moreover, carbon is not expensive. However, carbon may be lost in the process of firing a multilayer structure in which layers are stacked. And so, it is thought that strong reductive atmosphere is used as the firing atmosphere. However, the phosphoric acid salt-based solid electrolyte may be melted in the strong reductive atmosphere. In the following, a description will be given of a manufacturing method of the all solid battery that is capable of suppressing the carbon loss and the melting of the phosphoric acid salt-based solid electrolyte.

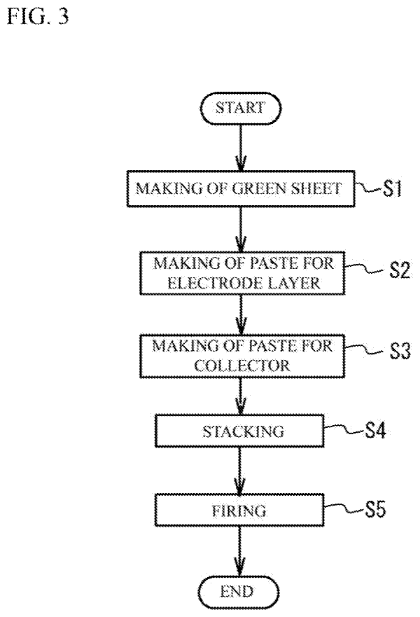

FIG. 3 illustrates a flowchart of the manufacturing method of the all solid battery 100 and the all solid battery 100a.

(Making process of green sheet) Powder of the phosphoric acid salt-based solid electrolyte structuring the solid electrolyte layer 30 is made. For example, it is possible to make the powder of the phosphoric acid salt-based solid electrolyte structuring the solid electrolyte layer 30, by mixing raw material and additives and using solid phase synthesis method or the like. The resulting powder is subjected to dry grinding. Thus, a grain diameter of the resulting power is adjusted to a desired one. For example, the grain diameter of the resulting power is adjusted to a desired one by a planetary ball mil using ZrO₂ balls having a diameter of 5 mm φ.

The resulting powder is evenly dispersed into aqueous solvent or organic solvent together with a binding agent, a dispersing agent, a plasticizer and so on. The resulting power is subjected wet crushing. And solid electrolyte slurry having a desired grain diameter is obtained. In this case, a bead mill, a wet jet mill, a kneader, a high pressure homogenizer or the like may be used. It is preferable that the bead mill is used because adjusting of particle size distribution and dispersion are performed at the same time. A binder is added to the resulting solid electrolyte slurry. Thus, solid electrolyte paste is obtained. The solid electrolyte paste is coated. Thus, a green sheet is obtained. The coating method is not limited. For example, a slot die method, a reverse coat method, a gravure coat method, a bar coat method, a doctor blade method or the like may be used. It is possible to measure grain diameter distribution after the wet crushing, with use of a laser diffraction measuring device using a laser diffraction scattering method.

(Making process of paste for electrode layer) Next, paste for electrode layer is made in order to make the first electrode layer 11 and the second electrode layer 21. For example, a conductive auxiliary agent, an active material, a solid electrolyte material, a binder, a plasticizer and so on are evenly dispersed into water or organic solvent. Thus, paste for electrode layer is obtained. The above-mentioned solid electrolyte paste may be used as the solid electrolyte material. Carbon materials may be used as the conductive auxiliary agent. When the composition of the first electrode layer 11 is different from that of the second electrode layer 21, paste for electrode layer used for the first electrode layer 11 and another paste for electrode layer used for the second electrode layer 21 may be individually made.

(Making process of paste for electric collector) Next, paste for electric collector is made in order to make the first electric collector layer 12 and the second electric collector layer 22. It is possible to make the paste for electric collector, by evenly dispersing powder of Pd, a binder, dispersant, plasticizer and so on into water or organic solvent.

(Stacking process) The paste for electrode layer and the paste for electric collector are printed on both faces of the green sheet, with respect to the all solid battery 100 described on the basis of FIG. 1. The printing method is not limited. For example, a screen printing method, an intaglio printing method, a letter press printing method, a calendar roll printing method or the like may be used. In order to make a stacked device having a thin layer and a large number of stacked layers, the screen printing is generally used. However, an ink jet printing may be preferable when a micro size electrode pattern or a special shape is necessary.

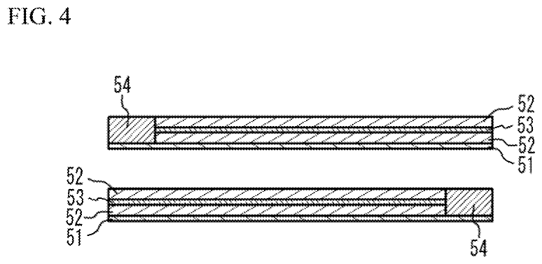

With respect to the all solid battery 100a described on the basis of FIG. 2, paste 52 for electrode layer is printed on one face of a green sheet 51 as illustrated in FIG. 4. Paste 53 for electric collector is printed on the paste 52 for electrode layer. And, another paste 52 for electrode layer is printed on the paste 53 for electric collector. A reverse pattern 54 is printed on a part of the green sheet 51 where neither the paste 52 for electrode layer nor the paste 53 for electric collector is printed. A material of the reverse pattern 54 may be the same as that of the green sheet 51. The green sheets 51 after printing are stacked so that each of the green sheets 51 is alternately shifted to each other. Thus, a multilayer structure is obtained. In this case, in the multilayer structure, a pair of the paste 52 for electrode layer and the paste 53 for electric collector are alternately exposed to the two edge faces of the multilayer structure.

(Firing process) Next, the obtained multilayer structure is fired. In the embodiment, an upper limit is determined in the oxygen partial pressure in the firing atmosphere, from a viewpoint of suppression of loss of the carbon included in the paste of electrode layer. In concrete, the oxygen partial pressure in the firing atmosphere is 2×10⁻¹³ atm or less. On the other hand, a lower limit is determined in the oxygen partial pressure in the firing atmosphere, from a viewpoint of suppression of the melting of the phosphoric acid salt-based solid electrolyte. In concrete, the oxygen partial pressure in the firing atmosphere is 5×10⁻²² atm or more. When the range of the oxygen partial pressure is determined in this manner, it is possible to suppress the carbon loss and the melting of the phosphoric acid salt-based solid electrolyte. An adjusting method of the oxygen partial pressure in the firing atmosphere is not limited.

For example, it is possible to use mixed gas of hydrogen gas and inert gas, mixed gas of CO₂ and Co, mixed gas of hydrogen gas and steam vapor, and so on. However, when CO₂—CO based mixed gas is used, the mixed gas may cause problems that the mixed gas generates lithium carbonate or the mixed gas intrudes into framework (lower ionic conductivity phase such as Li₂CO₃—Li₃PO₄ is generated). When the mixed gas of hydrogen gas and steam vapor is used, cost for capital investment may increase. It is therefore preferable that the mixed gas of hydrogen gas and the inert gas is used. Nitrogen gas may be used as the inert gas.

It is preferable that oxygen partial pressure in the firing atmosphere is 10⁻¹³ atm or less, from a viewpoint of suppression of carbon loss. It is more preferable that the oxygen partial pressure is 10⁻¹⁴ atm or less. It is still more preferable that the oxygen partial pressure is less than 10⁻¹⁶ atm. It is preferable that oxygen partial pressure in the firing atmosphere is 10⁻²² atm or more, from a viewpoint of suppression of melting of phosphoric acid-based solid electrolyte. It is more preferable that the oxygen partial pressure is 10⁻²¹ atm or more.

In the firing process, it is preferable that a maximum temperature is 400 degrees C. to 1000 degrees C. It is more preferable that that maximum temperature is 500 degrees C. to 900 degrees C. In order to sufficiently remove the binder until the maximum temperature, a process for keeping a temperature lower than the maximum temperature in an oxidizing atmosphere may be performed. It is preferable that the firing is performed in the lowest possible temperature, from a viewpoint of reduction of the process cost. After the firing, a re-oxidizing process may be performed. In this manner, the all solid battery 100 or the all solid battery 100a is manufactured.

In the manufacturing method of the embodiment, the oxygen partial pressure in the firing atmosphere is 5×10⁻²² atm or more and 2×10⁻¹³ atm or less. In this case, it is possible to suppress the carbon loss of the paste for electrode layer and the melting of the phosphoric acid salt-based solid electrolyte.

The carbon material is not limited. It is preferable that carbon black is used, because the carbon black is capable of effectively improving the conductivity. It is preferable that the amount of the carbon material is 30 vol. % or less, from a viewpoint of increasing of the amount of the active material and densifying of the electrode layers in the sintering. It is more preferable that the amount of the carbon material is 20 vol. % or less. It is preferable that the carbon material is 3 vol. % or more, from a viewpoint of securing of practical conductivity. It is more preferable that the amount of the carbon material is 5 vol. % or more. It is important to disperse the carbon material in the electrode layers so that macro aggregation is not formed and conductive network is formed. On the other hand, it is important to excessively disperse the carbon material, from a viewpoint of suppression of breaking of the conductive network. These theories may be common with those of general electrolytic solution-based lithium ion batteries. For example, the oxygen partial pressure is reduced in order to reduce the carbon loss in the firing process, in all solid batteries using an oxide solid electrolyte formed by the firing. When a part of the carbon material is lost in the firing, the amount of the carbon material is increased in order to compensate for the carbon loss.

### EXAMPLES

The all solid batteries in accordance with the embodiment were made and the property was measured.

### Example 1

Phosphoric acid salt-based solid electrolyte having a desirable grain diameter was dispersed into dispersion medium. Thus, solid electrolyte slurry was prepared. A binder was added to the solid electrolyte slurry. Thus, solid electrolyte paste was prepared. A green sheet was made by coating the solid electrolyte paste. Next, an electrode active material, solid electrolyte and carbon black were weighed in a wet bead mill. The electrode active material, the solid electrolyte and the carbon black were kneaded together with a solvent and a binder. Thus, slurry was obtained. The slurry was coated. Thereby, a sheet was formed. The sheet was used as an electrode sheet including carbon. Next, Pd powder was coated. Thereby, a sheet was formed. The sheet was used as an electric collector sheet. A plurality of green sheets were stacked. The stacked green sheets were used as a solid electrolyte layer. The electrode sheet including the carbon and the electric collector sheet were stacked on both an upper face and a lower face of the solid electrolyte layer. The resulting structure was stamped into a disk shape. The disk was used as a sample.

The samples were fired. The firing temperature was 700 degrees C. to 800 degrees C. In the example 1, the hydrogen gas concentration was 0.05 vol %, the nitrogen gas concentration was 99.95 vol %, and the oxygen partial pressure was 2×10⁻¹³ atm. In the example 2, the hydrogen gas concentration was 0.1 vol %, the nitrogen gas concentration was 99.9 vol %, and the oxygen partial pressure was 8×10⁻¹⁶ atm. In the example 3, the hydrogen gas concentration was 0.15 vol %, the nitrogen gas concentration was 99.85 vol %, and the oxygen partial pressure was 2×10⁻¹⁸ atm. In the example 4, the hydrogen gas concentration was 2 vol %, the nitrogen gas concentration was 98 vol %, and the oxygen partial pressure was 5×10⁻²² atm. In the comparative example 1, the hydrogen gas concentration was 0 vol %, the nitrogen gas concentration was 100 vol %, and the oxygen partial pressure was 3×10⁻⁵ atm. In the comparative example 2, the hydrogen gas concentration was 0.01 vol %, the nitrogen gas concentration was 99.99 vol %, and the oxygen partial pressure was 4×10⁻¹² atm. In the comparative example 3, the hydrogen gas concentration was 4 vol %, the nitrogen gas concentration was 96 vol %, and the oxygen partial pressure was 1×10⁻²³ atm.

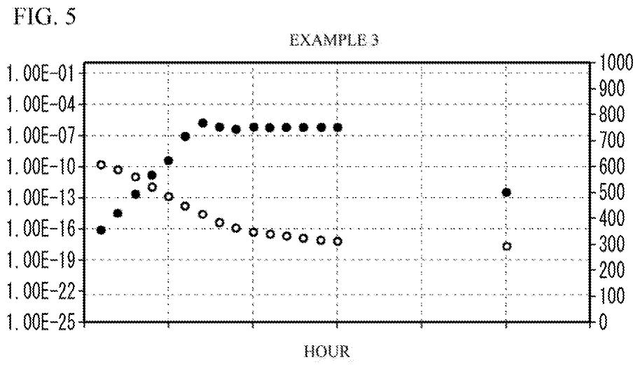

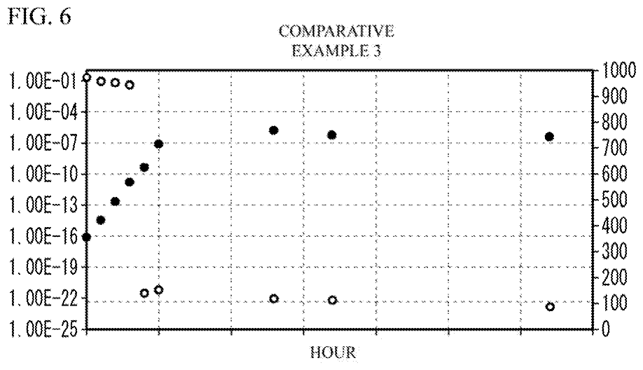

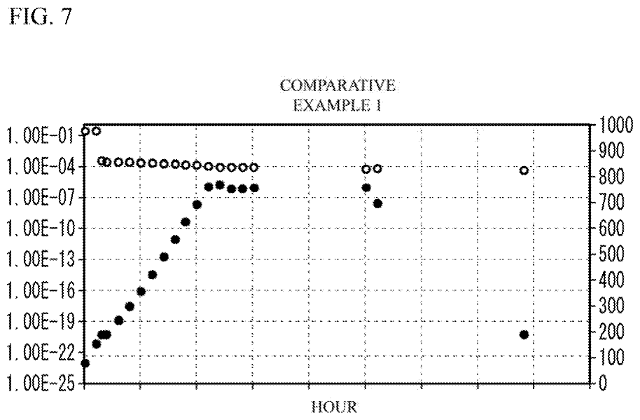

FIG. 5 illustrates aging of the oxygen partial pressure in the firing process of the example 3. In FIG. 5 to FIG. 7, black circles indicate the temperature (right vertical axis). White circles indicate the oxygen partial pressure (left vertical axis). As shown in FIG. 5, the temperature increased as the time passed, and kept approximately constant after that. The oxygen partial pressure decreased as the time passed, and kept approximately constant after that. The constant value was used as the oxygen partial pressure value. FIG. 6 illustrates aging of the oxygen partial pressure in the firing process of the comparative example 1. As shown in FIG. 6, the temperature increased as the time passed, and kept approximately constant after that. The oxygen partial pressure was approximately constant. FIG. 7 illustrates aging of the oxygen partial pressure in the firing process of the comparative example 3. As shown in FIG. 7, the temperature increased as the time passed, and kept approximately constant after that. The oxygen partial pressure rapidly decreased and kept approximately constant after that.

Each sample of the examples 1 to 4 and the comparative examples 1 to 3 after the firing was observed by SEM observation. And, it was confirmed whether the carbon was left or not in an electrode layer. And sintering condition of the phosphoric acid salt-based solid electrolyte was confirmed. Moreover, condition of Pd in the electrode layer was confirmed. Table 1 shows the results. As shown in Table 1, in the examples 1 to 4, the carbon was left, and loss of the carbon was suppressed. And, in the examples 1 to 4, sintering of the phosphoric acid salt-based solid electrolyte was confirmed. It is thought that this was because the oxygen partial pressure in the firing atmosphere was 5×10⁻²² atm or more.

TABLE 1

| | | | OXYGEN | | | | |
|---|---|---|---|---|---|---|---|
| | HYDROGEN | NITROGEN | PARTIAL | | | | |
| | CONCENTRATION | CONCENTRATION | PRESSURE | | | | TOTAL |
| | (vol %) | (vol %) | (atm) | Pd | CARBON | ELECTROLYTE | DETERMINATION |
| EXAMPLE 1 | 0.05 | 99.95 | 2 × 10⁻¹³ | ◯ | Δ | ⊚ | Δ |
| EXAMPLE 2 | 0.1 | 99.9 | 8 × 10⁻¹⁶ | ◯ | ◯ | ◯ | ◯ |
| EXAMPLE 3 | 0.15 | 99.85 | 2 × 10⁻¹⁸ | ◯ | ⊚ | ◯ | ⊚ |
| EXAMPLE 4 | 2 | 98 | 5 × 10⁻²² | ◯ | ◯ | Δ | Δ |
| COMPARATIVE | 0 | 100 | 3 × 10⁻⁵ | ◯ | X | ◯ | X |
| EXAMPLE 1 | | | | | LOST | | |
| COMPARATIVE | 0.01 | 99.99 | 4 × 10⁻¹² | ◯ | X | ◯ | X |
| EXAMPLE 2 | | | | | LOST | | |
| COMPARATIVE | 4 | 96 | 1 × 10⁻²³ | ◯ | ◯ | X | X |
| EXAMPLE 3 | | | | | | NOT | |
| | | | | | | SINTERED | |

On the other hand, in the comparative example 1, it was confirmed that the carbon was lost. It is thought that this was because the oxygen partial pressure of the firing atmosphere was more than 2×10⁻¹³ atm. In the comparative example 2, it was confirmed that the carbon was lost. It is thought that this was because the oxygen partial pressure of the firing atmosphere was more than 2×10⁻¹³ atm. In the comparative example 3, the carbon was left, but the phosphoric acid salt-based solid electrolyte was not sintered. It is thought that this was because the oxygen partial pressure of the firing atmosphere was less than 5×10⁻²² atm. With respect to conditions of Pd, the carbon and the electrolyte in each firing atmosphere, the following determination was performed. With respect to Pd, it was determined as good “circle”, when continuity of Pd was achieved in the SEM observation and oxygen (O) was not detected in element analysis. It was determined as “triangle”, when the continuity of pd was achieved and the oxygen (O) was detected. It was determined as bad “x”, when the continuity of Pd was not achieved. In thermogravimetric analysis under normal atmosphere, when the amount of the left carbon was 80% or more with respect to a theoretical amount, it was determined as very good “double circle”. When the amount of the left carbon was 50% or more and less than 80% with respect to the theoretical amount, it was determined as good “circle”. When the amount of the left carbon was more than 20% and less than 50% with respect to the theoretical amount, it was determined as so-so “triangle”. When the amount of the left carbon was 20% or less, it was determined as bad “cross”. With respect to the electrolyte, when a reduction amount Δσ of ionic conductivity (total conductivity in room temperature) with respect to a firing condition in normal atmosphere was 1×10⁻⁵ S/cm or less in the sintered structure formed by firing the electrolyte alone in the same firing condition, it was determined as very good “double circle”. When the reduction amount Δσ was more than 1×10⁻⁵ S/cm and less than 3×10⁻⁵ S/cm, it was determined as good “circle”. When the reduction amount Δσ was 3×10⁻⁵ S/cm or less, it was determined as so-so “triangle”. When the electrolyte was melted and was not sintered, it was determined bad “cross”. When one or more of the determinations of Pd, carbon and the electrolyte was determined as bad “cross”, it was totally determined as bad “cross”. When there is no determination of bad “cross” and there is one or more determinations of so-so “triangle”, it was totally determined as so-so “triangle”. When there are only determinations of good “circle”, it was totally determined as good “circle”. When there is no determinations of bad “cross” or so-so “triangle” and there is one or more determinations of very good “double circle”, it was totally very good “double circle”.

The condition of the left carbon material in the example 2 was better than that of the example 1. It is thought that this was because the oxygen partial pressure in the firing atmosphere was 10⁻¹⁴ atm or less in the example 2.

The condition of the left carbon material in the example 3 was better than that of the example 2. It is thought that this was because the oxygen partial pressure was less than 10⁻¹⁶ atm in the firing atmosphere in the example 3.

The sintering condition of the phosphoric acid salt-based solid electrolyte of the example 3 was better than that of the example 4. It is thought that this was because the oxygen partial pressure in the firing atmosphere was 10⁻²¹ atm or more in the example 3.

The condition of the left carbon material of the example 3 was the best. And the sintering condition of the phosphoric acid salt-based solid electrolyte was the best. It is thought that this was because the oxygen partial pressure in the firing process was 10⁻²¹ atm or more and less than 10⁻¹⁶ atm.

Although the embodiments of the present invention have been described in detail, it is to be understood that the various change, substitutions, and alterations could be made hereto without departing from the spirit and scope of the invention.

What is claimed is:

1. A manufacturing method of an all solid battery comprising:
preparing a multilayer structure in which first coated electric collector paste including Pd, first coated electrode paste including carbon, a green sheet including phosphoric acid salt-based solid electrolyte grains, second coated electrode paste including carbon and second coated electric collector paste including Pd are stacked in this order; and
firing the multilayer structure within an oxygen partial pressure range from 5×10⁻²² atm or more and 2×10⁻¹³ atm or less.

2. The method as claimed in claim 1, wherein the oxygen partial pressure range is adjusted by adjusting a mixing ratio of hydrogen gas and inert gas.

3. The method as claimed in claim 2, wherein the inert gas is nitrogen gas.

4. The method as claimed in claim 1, wherein the phosphoric acid salt-based solid electrolyte has a NASICON structure.
